(19) United States
(12) Patent Application Publication
(10) Pub. No.: US 2019/0335761 A1
(43) Pub. Date: Nov. 7, 2019

(54) Use of an extract or an extract fraction of agarophyte red algae as a plant defense elicitor/stimulator and application of said extract or said extract fraction

(71) Applicant: SOCIETE D'ETUDE ET D'EXPLOITATION D'ALGUES ET PRODUITS MARITIMES (SETEXAM), Kenitra (MA)

(72) Inventors: Céline FAUGERON-GIRARD, Saint Just Le Martel (FR); Vincent GLOAGUEN, Aixe sur Vienne (FR); Mohamed Salim LEBBAR, Kenitra (MA)

(21) Appl. No.: 16/404,797

(22) Filed: May 7, 2019

(30) Foreign Application Priority Data
May 7, 2018 (EP) 1870542

(51) Int. Cl. A01N 65/03

(52) U.S. Cl. CPC A01N 65/03

(57) ABSTRACT

Use as a defense elicitor/stimulator in terrestrial plants of an extract or an extract fraction of at least one agarophyte red alga, said extract or said extract fraction containing at least one oligosaccharide having 2 to 50 ose units covalently bound to one another, and polysaccharides having more than 50 ose units covalently bound to one another which can be contained without exceeding 0.01% by weight relative to the total oligosaccharides/polysaccharides.

The present invention relates to the use of extracts, in particular natural extracts, or fraction extracts of agarophyte red algae as natural defense stimulators in terrestrial plants. It also relates to methods for obtaining these extracts or extract fractions.

The present invention consists in the recovery of extracts of agarophyte red algae and their use as elicitors or stimulators of natural defenses having the ability to cause the plant to express resistance to biotic stress.

The use of chemicals such as pesticides in the agricultural field is subject to a limitation imposed in France by the Ecophyto 2 plan. The aim is to halve the use of phytopharmaceutical chemicals such as pesticides by 2025 while maintaining agricultural yields, which suggests the development and application of alternative methods such as the use of elicitors that will help to achieve the ambitions of the Ecophyto plan and reduce the risks and impacts associated with the use of pesticides in farming.

Elicitors are signaling molecules that initiate the recognition of a pathogenic microorganism in the plant. They are able to bind specifically to membrane receptors. As a result of the interaction between the elicitor and the specific receptor, a cascade of signaling events is observed at the cellular level. There is a wide variety of membrane receptors that may each accommodate a well-defined elicitor (Benhamou, N., and Rey, P. (2012). Stimulateurs des défenses naturelles des plantes: une nouvelle stratégie phytosanitaire dans un contexte d'écoproduction durable.: I. Principes de la résistance induite. Phytoprotection 92, 1).

In this sense, depending on the interaction, there is:
membrane depolarization, activation of G proteins, protein kinases, intracellular release of calcium ions;
the expression of defense genes participating in the biosynthetic pathway of phytohormones, enzymes, stress proteins, protease inhibitors, secondary metabolites with antimicrobial potential including phytoalexins;
the accumulation of active forms of oxygen or AFOs, very active molecules with direct antimicrobial activity, also involved in hypersensitivity reactions and in the reinforcement of the cell wall.

The accumulation of AFOs is an event that triggers the production of free radicals normally present in the plant in small quantities. During an attack, this balance is broken and the overproduction of free radicals is toxic for the pathogen but also for the plant because they can damage molecules such as DNA, proteins, certain enzymes and membrane lipids. The attack zone of the pathogen may thus be necrotic (hypersensitive reaction). To minimize this negative effect of AFOs, the plant has enzymes channeling their perimeter of action including peroxidase. The oxidative burst is therefore generally accompanied by a production of peroxidases, enzymes that deactivate the AFOs such as H₂O₂, which is therefore potentially a defense marker of the plant.

The signaling events vary from one plant to another in terms of intensity and order of appearance and play a major role in the transduction of the stress signal. Depending on the nature of the elicitor, different responses are put in place to resist the pathogen. Among these responses may be observed a parietal reinforcement. A papilla is synthesized where the pathogenic organisms enter.

The rapid and localized apposition of phenolic compounds, silica, callose, proteins, glycoproteins (HRGP), suberin or lignin can thicken the cell wall (Garcia-Brugger, A., Lamotte, O., Vandelle, E., Bourque, S., Lecourieux, D., Poinssot, B., Wendehenne, D., and Pugin, A. (2006) Early Signaling Events Induced by Elicitors of Plant Defenses. Microbe Interactions 19, 711-724, Senthil-Kumar, M., and Mysore, K S (2013), Nonhost Resistance Against Bacterial Pathogens: Retrospective and Prospects, Annual Review of Phytopathology 51,407-427).

The production of lignin in the attacked zone is carried out using catalytic enzymes such as phenylalanine ammonia-lyase (PAL) which is essential for the biosynthesis of phenylpropanoids.

The plant has a varied arsenal allowing it to defend itself and adapt to the type of stress to which it is subject. The type of resistance induced by the elicitors is acquired systemic resistance. It is a resistance generalized to the whole plant. It allows an optimized defense against the pathogen and against new potential attacks. In particular, it allows the plant to be in a constant state of standby as long as the effect of the SDN is active. It is a preventive method that induces resistance in the plant and significantly reduces the response time to the attack of a pathogen. The strategy adopted is to provide the plant with an elicitor at a low concentration, in order to considerably reduce the response time to aggression. (Levine, A., Tenhaken, R., Dixon, R., and Lamb, C. (1994), H202 from the oxidative burst orchestrates the plant hypersensitive disease resistance response, Cell 79, 583-593, Bolwell, G P (1999). Current Opinion in Plant Biology 2, 287-294).

Elicitors of biotic origin, abiotic stresses such as heavy metals, certain detergents, certain antibiotics, UV radiation may be distinguished. It is common to find biotic elicitors in algae. In fact, red, green and brown algae have varied and specific parietal polysaccharides capable of acting as biotic elicitors as such or in a depolymerized form (Vera, 2011). In particular, the red algae rich in carrageenans (or carrageenophytes) have carrageenans whose oligosaccharide derivatives have elicitor properties (US 20100173779 A1 and US 20110099898 A1). It should be noted that carrageenans differ from agars in the absence of agar-exclusive L-galactose and 3,6 anhydro-L-galactose. Some green algae have ulvans which, once depolymerized, act as elicitors (WO2005094588 A1). Regarding brown algae, the latter are rich in laminarin which is a reserve glucan acting as elicitor (WO 1994000993 A1). There are oligoagars of degree of polymerization (DP)4 obtained by enzymatic depolymerization and able to elicit the red alga Gracilaria (Weinberger, F., Friedlander, M., and Hoppe, B.-G. (1999). Oligoagars elicit a physiological response in Gracilaria conferta (Rhodophyta) Journal of Phycology 35, 747-755).

The Applicant Company has now discovered carbohydrates and carbohydrate fragments of agarophyte red algae such as those of the genera Gelidium and Gracilaria which exhibit eliciting activity. The recovery of these substances of natural origin is carried out with the objective of an biological application that is respectful of the environment. These natural substances do not require prior depolymerization to activate their elicitor character; they are active as such. Also, these elicitor substances are water-soluble, which reinforces their natural character.

The invention thus relates, in particular, to extracts of molecules naturally present in Gelidium sesquipedale and capable of causing an increase in certain markers of elicitation, such as callose, phenolic compounds, enzymatic activities of peroxidase and of phenylalanine-ammonia-lyase (PAL). The invention makes it possible to improve the acquired systemic resistance and/or the induced systemic resistance by accelerating its establishment and by ensuring a generalized defense in the plant.

Japanese patent application JP 2014091709 discloses plant growth promoters consisting of an alkali-treated water obtained after the alkaline treatment of a red algae and washing the treatment water obtained during a method for producing agar. This is an application different from that according to the present invention, these agents being presented as containing minerals from seawater in a well-balanced manner, such minerals participating in the growth of the plant.

Antonio Ramkissoon, Adesh Ramsubhag and Jayaray Jayaraman, J. Appl. Phycol (2017) 29: 3235-3244 describe the phytoelicitant activity of extracts of three species of Caribbean algae causing the decrease of symptoms of pathogenic infections in tomato plants. The extracts obtained are complex mixtures of molecules. In contrast to this, the present invention relates to extracts or extract fractions containing well-defined oligosaccharides, never mentioned in the cited article. Moreover, according to this article, the extract is sprayed at a concentration of 0.5%, i.e. 5 g/L. According to the present invention extracts/extract fractions have been applied at much more favorable concentrations for plants, which are between 1 and 10 mg/L, i.e. about 1000 times lower. This corroborates the novelty and the interest of extracts/extract fractions according to the present invention.

The present invention firstly relates to an use as a defense elicitor/stimulator in terrestrial plants of an extract or an extract fraction of at least one agarophyte red alga, said extract or said extract fraction containing at least one oligosaccharide having from 2 to 50 ose units covalently bound to one another, and polysaccharides having more than 50 ose units covalently bound to one another, which may be contained without exceeding 0.01% by weight relative to total oligosaccharides/polysaccharides.

An oligosaccharide is defined here as a compound containing from 2 to 50 ose units and a polysaccharide as a compound containing more than 50 ose units.

The term “degree of polymerization” (DP) is also used below to express this number of ose units.

The agarophyte red algae may be chosen from those of the genera Gelidium and Gracilaria, and may in particular be Gelidium sesquipedale.

In particular, the extract or the extract fraction may contain, as oligosaccharide(s), at least one native or substituted oligosaccharide chosen from:
a (Gal)ₙ-Glycerol with Gal=galactose unit and 2≤n≤4;
a disaccharide consisting of two hexose units;
a disaccharide consisting of two galacturonic acid units.

The extract or the extract fraction may also contain at least one monosaccharide, native or substituted by glycerol or a methyl, the one or more monosaccharides may be selected from floridoside/isofloridoside (Gal-glycerol), 3,6-anhydrogalactose, galacturonic acid, hexoses or pentoses.

The extract may consist of an extract:
by an alkaline aqueous solution at basic pH, in particular with sodium hydroxide at 0.1-10% by weight, preferably 2-5% by weight, followed by neutralization with an acid and at least partial elimination of polysaccharides having more than 50 ose units connected to each other covalently, for example by precipitating the filtrate with ethanol; or
by a hydroalcoholic solution, the alcohol having subsequently been eliminated; or
by an alcohol such as ethanol, the alcohol having subsequently been eliminated,

an extract which may also be: one of the aqueous phases obtained by the filtrations carried out during the method of extracting the agar from an agarophyte red algae respectively after alkaline treatment of the algae, after rinsing the residue thus obtained with water, after neutralization with acid of the residue obtained during this rinsing, after rinsing the residue obtained during this neutralization with water; or the extract obtained by the hot extraction of the residue obtained at the same time as the agar gel during hot extraction/filtration of the residue obtained after this last rinsing with water; and the syneresis juice obtained after freeze-thawing and/or by mechanical pressing of this agar gel,

and an extract fraction results from fractionation of an extract by ultrafiltration or size exclusion chromatography,

the extract or extract fraction may then have been concentrated, dehydrated or lyophilized.

The extract or the extract fraction may have been prepared by a method according to which an aqueous, alcoholic or hydroalcoholic extraction has been carried out, while hot, of the one or more agarophyte red algae, with subsequent removal of the alcohol in the case of an alcoholic or hydroalcoholic extraction,

the extraction being able to be an aqueous alkaline extraction, in particular an aqueous alkaline extraction, according to which, after the alkaline treatment and by filtration, is obtained, on the one hand, an aqueous phase (A1) and on the other hand a residue (R1);

and then rinsing with distilled water of said residue (R1) to obtain after filtration, on the one hand, an aqueous phase (A2) and, on the other hand, a residue (R2);

then acid neutralization of said residue (R2) may be carried out to obtain, after filtration, on the one hand, an aqueous phase (A3) and, on the other hand, a residue (R3);

then it is possible to rinse said residue (R3) with distilled water to obtain, after filtration, on the one hand, an aqueous phase (A4) and, on the other hand, a residue (R4);

then a hot extraction and a filtration of said residue (R4) may be carried out to obtain, on the one hand, a residue (R5) and, on the other hand, an agar gel;

and then extraction with hot water of said residue (R5) may be carried out to obtain an aqueous phase (A5);

then a freeze-thawing and/or mechanical pressing of the agar gel may be carried out to obtain, on the one hand, a syneresis juice (JS) and a pure agar gel;

said aqueous phases (A1) to (A5) and the syneresis juice (JS) each also representing a desired extract,

said extract may be subjected to a treatment with ethanol to obtain on the one hand, an ethanolic extract (EE) and on the second hand a precipitate, the ethanolic extract being subjected to fractionation by ultrafiltration or by size exclusion allowing isolation of an extract fraction containing at least one oligosaccharide having from 2 to 50 ose units covalently bound to one another, and polysaccharides having more than 50 ose units covalently bound to one another, which can be contained without exceeding 0.01% by weight relative to total oligosaccharides/polysaccharides,

said extract or extract fraction may then have been concentrated, dehydrated or lyophilized.

The extract or the extract fraction may be in an aqueous medium, or may be in powder form.

The invention also relates to a method for stimulating natural defense in a terrestrial plant, characterized in that it consists in applying to the whole of the plant or to a part thereof, comprising the vegetative apparatus, root system, fruits, grains and seeds of the plant, or on the soil or substrate for culturing the plant, an amount sufficiently effective to stimulate the natural defenses of the plant, of the extract or of the extract fraction as defined in the present invention, in the liquid state or in the form of powder or granules.

We may treat agronomically useful plants, field crops, including oilseeds such as sunflower or soy, protein crops such as chickpea, cereals such as corn or wheat, fruit trees such as pear trees, apple trees, nectarine trees, horticultural plants such as rose bushes, grassland plants, and market garden plants such as tomato, melon, lettuce or spinach.

The liquid extract or the liquid extract fraction may be applied to the plant or part of the plant or grains or seeds or to the soil or substrate at an oligosaccharide concentration of 0.0001 to 100 g/L, preferably from 1 to 10 mg/L. The extract or extract fraction may also be applied in the liquid state or in the form of powder or granules at a rate of 1 to 1000 g of oligosaccharides per hectare.

The application may be carried out 1 to 20 times, preferably 3 to 5 times per year of culture.

The invention also relates to a composition for the implementation of the method according to the invention, characterized in that it consists of an extract or extract fraction as that defined above, as a liquid or in the form of a powder or granules and, where appropriate, incorporated in a phytosanitary or fertilizer product or with at least one adjuvant chosen from surfactants, dispersants, preserving agents, anti-caking agents, trace elements, amendments, deficiency-correcting agents, fungicides, insecticides, herbicides, growth hormones.

### EXAMPLE 1 OBTAINING AN ALKALINE EXTRACT AND FRACTIONATION

100 g dry algae Gelidium sesquipedale are mixed with 1500 mL of a 2% w/v sodium hydroxide solution and stirred for 1 hour at 70-80° C. It is neutralized with sulfuric acid at 1% by volume.

Then, the mixture is filtered on a nylon fabric with a porosity of 53 μM. Insoluble particles are retained on the filter and eliminated.

The polysaccharide fraction with a degree of polymerization greater than about 50 is removed by precipitation with 3 volumes of ethanol.

The ethanolic fraction contains, in particular, the oligosaccharides and monosaccharides. Then, the ethanol is removed by rotary evaporation to obtain an aqueous solution of extract.

### EXAMPLE 2 FRACTIONATION OF THE EXTRACT OF EXAMPLE 1 BY ULTRAFILTRATION

The filtrate (or aqueous extract solution) obtained is fractionated by ultrafiltration on a membrane of 5 kDa porosity at first in order to remove compounds with masses greater than or equal to 5000 Da (including polysaccharides) and contained in the retentate.

The permeate is recovered and subjected to ultrafiltration on a 1000 Da membrane, which allows the production of oligosaccharide-enriched fractions in the 1000 Da retentate.

Fractions were characterized using colorimetric assays of oses according to the method of Dubois et al. (DuBois, M., Gilles, K A., Hamilton, J K, Rebers, P A, and Smith, F. (1956), Colorimetric Method for Determination of Sugars and Related Substances, Analytical Chemistry 28, 350-356), of uronic acids (Blumenkrantz, N., and Asboe-Hansen, G. (1973), New methods for quantitative Determination of uronic acids, Analytical Biochemistry 54, 484-489), of phenolic compounds (Singleton Method, Singleton V L & Rossi, J A Jr., Colorimetry of Total, phenolics with phosphomolybdic-phosphotungstic acid reagents, Amer J. J. Enol, Viticult 16: 144-58, 1965), of proteins (Bradford, M M (1976). A rapid and sensitive method for the quantitation of microgram quantities of protein utilizing the principle of protein-dye binding, Analytical Biochemistry 72, 248-254). Then, the monosaccharide composition is established by GPC after obtaining alditol acetate derivatives according to Stevenson, T. T., and Furneaux, R. B. (1991). Chemical methods for the analysis of sulphated galactans from red algae. Carbohydrate Research 210, 277-298. The solids content of the extract is determined by weighing after lyophilization.

TABLE 1
Compositions determined by colorimetric assays (% by mass)

| | % | % | % | | mg | |
|---|---|---|---|---|---|---|
| | uronic | neutral | phenolic | % | SO4/mg | % in- |
| Fraction | acid | ose | compounds | proteins | ose | organic |
| Re 5 kDa | 1.6 | 51.4 | 3.2 | 1.3 | 1.8 | 39 |
| Pe 5 kDa | 0.4 | 38.6 | 0.4 | 0.6 | 1.6 | 40.7 |
| Re 1 kDa | 0.8 | 81.3 | 0.9 | 2.2 | 0.5 | 14.3 |
| Pe 1 kDa | 0.4 | 29.9 | 0.1 | 0.4 | 1 | 45.4 |

Re: retentate
Pe: permeate

The colorimetric assays are indicative of a predominance of carbohydrates. The fractions also have proteins, phenolic compounds and uronic acids but in proportions lower than that in neutral oses. The carbohydrates present have sulphate functions whose proportion differs according to the fraction.

TABLE 2
Monosaccharide composition (mol %)

| Fraction | 3,6 An-Gal | Gal | Xyl | Glc | Man | Fuc | Rha | Gal A | Glc A | 6-O—Me-Gal |
|---|---|---|---|---|---|---|---|---|---|---|
| Re 5 kDa | 48 | 12 | 18 | ND | 1 | 1 | 2 | 10 | 5 | 3 |
| Pe 5 kDa | 20 | 44 | 12 | 2 | 7 | 11 | ND | 2 | 1 | 1 |
| Re 1 kDa | 28 | 25 | 29 | 1 | 1 | 5 | ND | 4 | 7 | ND |
| Pe 1 kDa | 37 | 25 | 20 | 4 | 5 | 9 | ND | ND | ND | ND |

3,6 An-Gal: 3,6-anhydrogalactose;
Gal: Galactose;
Xyl: Xylose;
Glc: Glucose;
Man: Mannose;
Fuc: Fucose;
Rha: Rhanmose;
Gal A: galacturonic acid;
Glc A: Glucuronic added;
6-O—Me-Gal: 6-O-methylgalactose
ND: not detected
Re: Retentate
Pe: Permeate

It is observed in the monosaccharide composition deduced from GPC analysis that Galactose is predominant, especially in its 3,6 anhydrogalactose form.

TABLE 3
Mass yield

| Fraction | Mass percentage relative to the starting mass of algae (% MS) |
|---|---|
| Re 5 kDa | 5.2 |
| Pe 5 kDa | 32.9 |
| Re 1 kDa | 5.8 |
| Pe 1 kDa | 26.4 |

The mass yields reflect an unequal mass distribution of the retentate and permeate from ultrafiltration at 5 kDa and it can be observed that the compounds whose size is greater than 5 kDa represent 5% of the initial dry weight of algae and that 33% by weight of the initial dry biomass is recovered in the permeate and therefore contains compounds smaller than 5 kDa.

The 1 kDa ultrafiltration performed on the permeate recovered during ultrafiltration at 5 kDa makes it possible to obtain a new permeate and a retentate with a distribution close to that obtained for ultrafiltration at 5 kDa.

The 1 kDa ultrafiltration also allows to remove the inorganic compounds and mono and disaccharides in the permeate.

### EXAMPLE 3 OBTAINING AN AQUEOUS OR ALCOHOLIC OR HYDROALCOHOLIC EXTRACT

100 g of dry algae are mixed with 1 L of water or ethanol or a water-ethanol mixture (20/80 v/v) and stirred for 1 hour at 50-60° C. Then the mixture is filtered on nylon fabric with a porosity of 53 μm. Insoluble particles are retained on the filter and removed.

TABLE 4
Percentage of neutral oses of the fraction

| Fraction | % ON |
|---|---|
| Extraction H₂O | 15.2 |
| Extraction H₂O/EtOH | 54 |
| Extraction EtOH | 1.5 |

TABLE 5
Mass percentage of the fraction relative to the mass of starting dry algae

| Fraction | Mass percentage (% dry material) |
|---|---|
| Extraction H₂O | 1.93 |
| Extraction H₂O/EtOH | 0.49 |
| Extraction EtOH | 0.19 |

The extraction with water or with ethanol makes it possible to recover fractions containing carbohydrates ranging from 1 to 15% by weight of the fraction.

The extraction carried out with a mixture of water and ethanol makes it possible to recover a fraction containing 52-54% of oses. The mass yields of extractions carried out with water, with ethanol, or with a water-ethanol solvent do not exceed 2% relative to the mass of dry algae.

### EXAMPLE 4 FRACTIONATION OF THE EXTRACT OF EXAMPLE 1 BY SIZE EXCLUSION CHROMATOGRAPHY

The aqueous extract solution obtained in Example 1 is fractionated by size exclusion column chromatography with, as stationary phase, polyacrylamide gel with a cutoff of 100-1800 Da. The mobile phase is degassed ultrapure water; the flow rate is 0.18 ml/min⁻¹. The fractions collected are 1.8 ml. They are analyzed by TLC and those containing carbohydrates and having the same profile are combined: three fractions are obtained F1, F2 and F3.

These fractions were characterized using colorimetric assays, by GPC and by ESI-MS.

Table 6 below gives the mass yield.

TABLE 6

| | Mass percentage relative to the starting mass of algae (% dry |
|---|---|
| Fraction | materials) |
| F1 | 3.4 |
| F2 | 3.2 |
| F3 | 1.8 |

Fractions F1 and F2 each represent 3-4% by weight of the starting algae mass, while fraction F3 represents 1.8%.

Table 7 below gives the compositions determined by colorimetric assays.

TABLE 7

| | % | % | | | SO4 | |
|---|---|---|---|---|---|---|
| | uronic | neutral | % | % | moles/ | % in- |
| | acid | oses | phenols | proteins | ose mole | organic |
| Fraction | (% mass/fraction) | | | | | |
| F1 | 2.1 | 32.0 | 2.0 | 4.7 | 0.5 | 17 |
| F2 | 0.9 | 15.4 | 0.7 | 0.6 | 0.1 | 0.3 |
| F3 | 0.5 | 9.6 | 0.3 | 0.6 | 0.3 | 1 |

Colorimetric assays show a preponderance of carbohydrates. The fractions also have proteins, phenolic compounds and uronic acids and the recovered monosaccharides are sulphated, especially in the fractions F1 and F3.

Table 8 below gives the monosaccharide composition (mol %) of fractions F1, F2 and F3.

TABLE 8

| Fraction | 3,6 An-Gal | Gal | Xyl | Glc | Man | Fuc | Gal A |
|---|---|---|---|---|---|---|---|
| F1 | 40.2 | 18.6 | 8.2 | 2.0 | 18.1 | 7.9 | 5.0 |
| F2 | 38.1 | 8.9 | 5.9 | 2.0 | 16.4 | 8.2 | 20.5 |
| F3 | 3.2 | 86.3 | 3.5 | 3.1 | 3.9 | ND | ND |

3,6 An-Gal: 3,6-anhydrogalactose;
Gal: Galactose;
Xyl: Xylose;
Glc: Glucose;
Man: Mannose;
Fuc: Fucose;
Gal A: galacturonic acid
ND: not detected

It is observed in the monosaccharide composition deduced from GPC analysis that Galactose predominates, especially in its 3,6-anhydrogalactose form. There is also the presence of xylose, glucose, mannose, fucose, galacturonic acid.

Composition of fractions F1, F2 and F3 by electrospray ionization spectrometry (ESI):

### ESI Spectrum of the F1 Fraction:

| | Theoretical | | |
|---|---|---|---|
| | mass | | |
| Observed mass m/z | (MW) | DP | Identified compound |
| 170.97 = M − H + 2Na | 125.99 | | Isethionic acid |
| 161.05 = M − H | 162.06 | 1 | 3.6 anhydrogatactose |
| 179.06 = M − H | 183.06 | 1 | Hexose |
| 203.06 = M − H + Na | | | |
| 277.1 = M − H + Na | 254.1 | 1 | Floridoside/isofloridoside |
| 365.12 = M − H + Na | 342.12 | 2 | (Hexose)₂ |
| 393.22 = M − H + Na | 370.22 | 2 | (Garaduronic acid)₂ |

In the negative mode spectrum is observed the presence of 3,6-anhydrogalactose and hexose (galactose, mannose or glucose) of DP1.

The presence of hexose of DP1, isethionic acid, floridoside/isofloridoside, DP2 hexose, and DP2 galacturonic acid is observed in the positive mode spectrum.

### ESI Spectra of the F2 Fraction

| | Theoretical | | |
|---|---|---|---|
| | mass | | |
| Observed mass m/z | (MW) | DP | Identified compound |
| 170.97 = M − H + 2Na | 125.99 | | Isethionic acid |
| 161.05 = M − H | 162 | 1 | 3.6 anhydrogatactose |
| 203.06 = M − H + Na | 180 | 1 | Hexose |
| 277.1 = M − H + Na | 264 | 1 | Floridoside/isofloridoside |
| 365.12 = M − H + Na | 342 | 2 | (Hexose)₂ |
| 439.16 = M − H + Na | 416 | 2 | Derivative of floridoside: |
| | | | (hexose)₂-glycerol |
| 527.17 = M − H + Na | 504 | 3 | (Hexose)₃ |
| 601.21 = M − H + Na | 578 | 3 | Derivative of floridoside: |
| | | | (hexose)₃-glycerol |
| 659.22 = M − H + Na | 666 | 4 | (Hexose)₄ |
| 763.26 = M − H + Na | 740 | 4 | Derivative of floridoside: |
| | | | (hexose)₄-glycerol |

The presence of 3,6-anhydrogalactose and DP1 hexose is observed in the negative mode spectrum. In the positive mode spectrum, there is the presence of DP1-4 hexose, isethionic acid, floridoside/isofloridoside, DP2 floridoside derivatives i.e. 2 hexoses and one glycerol function, DP3 i.e. 3 hexoses and one glycerol function, and DP4 i.e. 4 hexoses and one glycerol function.

ESI Positive Mode Spectrum of the F3 Fraction

| | Theoretical | | |
|---|---|---|---|
| | mass | | |
| Observed mass m/z | (MW) | DP | Identified compound |
| 170.97 = M − H + 2Na | 125.99 | | Isethionic acid |
| (traces) | | | |
| 277.1 = M − H + Na | 254 | 1 | Floridoside/isofloridoside |
| 439.16 = M − H + Na | 416 | 2 | Derivative of floridoside: |
| | | | (hexose)₂-glycerol |
| 601.21 = M − H + Na | 578 | 3 | Derivative of floridoside: |
| | | | (hexose)₃-glycerol |

Isethionic acid, floridoside/isofloridoside and floridoside derivatives of DP2 and DP3 are observed in the positive mode spectrum.

MS/MS spectrum of peaks corresponding to the mass of 253 Da attributed to floridoside/isofloridoside (M-H):

| Theoretical m/z | |
|---|---|
| (Chen et al. 2014) | Experimental m/z |
| 59.51 | 59.01 |
| 71.37 | 71.01 |
| 87.38 | 89.02 |
| 101.21 | 101.02 |
| 119.27 | 119.03 |
| 125.23 | 125.02 |
| 161.22 | 161.04 |

Juanjuan Chen, Dandan Song, Qijun Luo, Tong Mou, Rui Yang, Chen Haimin, Shan He, and Xiaoj a Yan (2014). Determination of Floridoside and Isofloridoside in Red Algae by High-Performance Liquid Chromatography-Tandem Mass Spectrometry Analytical Letters Volume 47, Pages 2307-2316

It is noted that the peaks of the theoretical fragmentation spectrum (MS/MS) of floridoside/isofloridoside correspond to those obtained experimentally. This demonstrates the presence of floridoside/isofloridoside in fractions F1 to F3.

MS/MS spectrum of the peak corresponding to the mass of 416 Da attributed to the floridoside derivative of DP2 (M-H)

The m/z peak at 416 corresponding to the DP2 derivative of floridoside is present and, after fragmentation (loss of a hexose), the peaks of the fragmentation spectrum of the m/z peak at 253 experimental appear. This shows the presence of floridoside derivatives at DP2 (peak corresponding to a mass of 416 Da) in the fractions F2 and F3. After fragmentation of a hexose, the fragmentation spectrum of floridoside/isofloridoside is found.

MS/MS spectra of the peak corresponding to the mass of 601 Da attributed to the floridoside derivative of DP3 (M-H):

| | Observed mass | | |
|---|---|---|---|
| Experimental m/z | (MW) | DP | Identified compound |
| 277.09 = M − H + Na | 254 | 1 | Floridoside/isofloridoside |
| 439.15 = | 416 | 2 | Derivative of floridoside: |
| M − H + Na | | | (hexose)₂-glycerol |
| 601.19 = | 578 | 3 | Derivative of floridoside: |
| M − H + Na-glycerol | | | (hexose)₃-glycerol |

Fragmentation of the peak at 601 demonstrates the presence of floridoside derivatives of DP3 in the F2 and F3 fractions.

Analysis of ESI Spectrometric Analyzes:

| Family | DP | MW | F1 | F2 | F3 |
|---|---|---|---|---|---|
| Iesthionic acid | | 125.99 | (+) | (+) | (+)traces |
| 3,6-AnGal | 1 | 162.05 | (−) | (−) | |
| Hexose Gal.Man.Glc | 1 | 180.06 | (+)/(−) | (+)/(−) | |
| | 2 | 342.12 | (+) | (+) | |
| | 3 | 504.17 | | (+) | |
| | 4 | 666.22 | | (+) | |
| Galacturonic acid | 2 | 370.22 | (+) | | |
| | 1 | 254.10 | (+) | (+) | (+)/(−) |
| Floridoside/isofloridoside | 2 | 416.16 | | (+) | (+)/(−) |
| and derivatives | 3 | 578.21 | | (+) | (+)/(−) |
| | 4 | 740.26 | | (+) | |

Legend:
Bold Majority species of the fraction
(+) Species observed in positive mode
(−) Species observed in negative mode

### EXAMPLE 5 EFFECT OF THE FRACTIONS OF EXAMPLE 4 ON THE ACTIVATION OF DEFENSE MECHANISMS IN PLANTS AS A RESULT OF BIOTIC STRESS

Batches of tomato plants are grown (Solanum lycopersicum marmande variety). A batch of 6 weeks old plants, homogeneous, is constituted (color, number of leaves). The fractions obtained according to Example 4 are prepared as a 1, 2 and 10 mg/L solution in 0.05% by volume Tween. They are applied as a foliar spray until run-off on tomato seedlings at T 0, T 2D and T 5D and 4 seedlings are used per experiment.

100 μl of a spore suspension of the fungus Botrytis cinerea at 10⁵-10⁶ spores/ml of 0.05% by volume Tween are deposited at T 7D on the leaves. The leaves are harvested at T 14D, frozen in liquid nitrogen and stored at −20° C. until analysis.

This consists of assaying markers of elicitation such as the callose content, the content of phenolic compounds, the enzymatic activity of peroxidase and phenylalanine-ammonia-lyase.

The results represent the average of three different and independent crops (four plants per modality and per harvest).

The callose content and the content of phenolic compounds are respectively determined according to Hirano, Y., Pannatier, E. G., Zimmermann, S., and Brunner, 1. (2004). Induction of callose in roots of Norway spruce seedlings after short-term exposure to aluminum. Tree Physiology 24, 1279-1283) and Singleton V L & Rossi J, Jr. Colorimetry of total phenolics with phosphomolybdic-phosphotungstic acid reagents. Amer. J. Enol. Viticult. 16: 144-58, 1965.

The enzymatic activity of peroxidase is determined according to the method described by Shindler J S, Childs R E, Bradsley W G. (1976) Peroxidase from human cervical mucus, the isolation and characterization. Eur J Biochem.; 65 (2): 325-331.; that of the PAL according to Francini, A, Nali, c., Pellegrini, E, and Lorenzini, G. (2008). Characterization and isolation of some genes of the shikimate pathway in sensitive and resistant Centaurea jacea plants after ozone exposure. Environmental Pollution 151, 272-279.

The results are expressed as a percentage of the control, Tween at 0.05% by volume.

The fraction F3 applied to the tomato plants at a concentration of 1 mg/L causes an increase in the callose content twice that of the control and at a concentration of 2 mg/L, the callose content is tripled. The F1 fraction at 1 mg/L causes an increase in the content of phenolic compounds which undergoes an increase of about 50% compared with the control.

TABLE 9
Callose content expressed as a percentage of the control

| | Concentation (mg/L) | | |
|---|---|---|---|
| Fractions | 1 | 2 | 10 |
| F1 | 118 | 170 | 159 |
| F2 | 141 | 114 | 123 |
| F3 | 109 | 291 | 159 |

TABLE 10
Content of phenolic compounds expressed as a percentage of the
control

| | Concentration (mg/L) | | |
|---|---|---|---|
| Fractions | 1 | 2 | 10 |
| F1 | 143 | 149 | 154 |
| F2 | 103 | 65 | 109 |
| F3 | 120 | 97 | 102 |

A concentration of the F1 fraction of 1 mg/L stimulates peroxidase activity by 70%. A concentration of the F1 fraction of 2 mg/L enhances the enzymatic activity of phenylalanine-ammonia-lyase by 82%.

TABLE II
Enzymatic activity of peroxidase expressed as a percentage of the
control

| | Concentration (mg/L) | | |
|---|---|---|---|
| Fractions | 1 | 2 | 10 |
| F1 | 154 | 169 | 157 |
| F2 | 136 | 88 | 168 |
| F3 | 135 | 114 | 81 |

TABLE 12
Enzymatic activity of the PAL expressed as a percentage of the
control

| | Concentration (mg/L) | | |
|---|---|---|---|
| Fractions | 1 | 2 | 10 |
| F1 | 182 | 134 | 37 |
| F2 | 169 | 116 | 119 |
| F3 | 86 | 100 | 108 |

The results obtained make it possible to affirm that the extracted fractions do indeed have an eliciting activity.

It is demonstrated that the fractions obtained according to Example 2 have an eliciting activity because the markers of elicitation are higher in the treated plants than in the control plants. Also, the response of the plant is different depending on the fraction applied. The three fractions cause an increase in the activity of peroxidase in a variable manner according to the concentration applied to the plants.

The peroxidase enzyme is synthesized when the plant produces AFO to limit oxidative stress. In addition, the enzyme phenylalanine-ammonia-lyase, participating in the pathway of biosynthesis of antimicrobial phenylpropanoids but also to the synthesis of lignins and thus the strengthening of the cell wall, sees its activity stimulated.

The reinforcement of the wall also comprises the formation of callose and phenolic compounds, the content of which is increased by the application of isolated fractions of Gelidium. Stimulation of these natural defenses can slow down the pathogen and is one of the first signs of resistance of the plant. The plant can better defend itself in the presence of extracts and fractions according to the invention.

The elicitor fractions give the plant an increased resistance by activating and reinforcing the markers of elicitation.

1. A method for stimulating natural defense in a terrestrial plant, consisting in applying to the whole of the plant or to a part thereof, comprising the vegetative apparatus, root system, fruit, grains and seeds of the plant, or on the soil or substrate for culturing the plant, an amount sufficiently effective to stimulate the natural defenses of the plant, of an extract or of an extract fraction of at least one agarophyte red alga, the extract or the extract fraction containing at least one oligosaccharide having 2 to 50 ose units covalently bound to one another, and polysaccharides having more than 50 ose units covalently bound to one another which can be contained without exceeding 0.01% by weight relative to the total oligosaccharides/polysaccharides.

2. The method according to claim 1, wherein the agarophyte red algae are chosen from those of the genera Gelidium and Gracilaria.

3. The method according to claim 2, wherein the agarophyte red alga is Gelidium sesquipedale.

4. The method according to claim 1, wherein the extract or the extract fraction contains, as oligosaccharide (s), at least one native or substituted oligosaccharide chosen from:
a (Gal)ₙ-Glycerol with Gal=galactose unit and 2≤n≤4;
a disaccharide consisting of two hexose units;
a disaccharide consisting of two galacturonic acid units.

5. The method according to claim 1, wherein the extract or the extract fraction also contains at least one native monosaccharide or substituted with glycerol or with a methyl.

6. The method according to claim 5, wherein the one or more monosaccharides are chosen from floridoside/isofloridoside (Gal-glycerol), 3,6-anhydrogalactose, galacturonic acid, hexoses or pentoses.

7. The method according to claim 1, wherein the extract is selected among extracts:
by an alkaline aqueous solution at basic pH, followed by neutralization with an acid and at least partial elimination of polysaccharides having more than 50 ose units covalently bound to one another; and
by a hydroalcoholic solution, the alcohol having subsequently been eliminated; and
by an alcohol such as ethanol, the alcohol having subsequently been eliminated,

8. The method according to claim 7, wherein the alkaline aqueous solution at basic pH is sodium hydroxide at 0.1-10% by weight.

9. The method according to claim 1, wherein the extract is selected among:
an extract which may also be: one of the aqueous phases obtained by the filtrations carried out during the method of extracting the agar from an agarophyte red algae respectively after alkaline treatment of the algae, after rinsing the residue thus obtained with water, after neutralization with acid of the residue obtained during this rinsing, after rinsing the residue obtained during this neutralization with water; and
the extract obtained by the hot extraction of the residue obtained at the same time as the agar gel during hot extraction/filtration of the residue obtained after this last rinsing with water; and the syneresis juice obtained after freeze-thawing and/or mechanical pressing of this agar gel,

10. The method according to claim 1, wherein an extract fraction results from fractionation of an extract by ultrafiltration or size exclusion chromatography,

11. The method according to claim 1, wherein the extract or the extract fraction has been prepared by a method according to which an aqueous, alcoholic or hydroalcoholic extraction has been carried out, while hot, of the one or more agarophyte red algae, with subsequent removal of the alcohol in the case of an alcoholic or hydroalcoholic extraction, the extraction being able to be an aqueous alkaline extraction, in particular an aqueous alkaline extraction, according to which, after the alkaline treatment and by filtration, is obtained, on the one hand, an aqueous phase (A1) and on the other hand a residue (R1);
and then rinsing with distilled water of the residue (R1) to obtain after filtration, on the one hand, an aqueous phase (A2) and, on the other hand, a residue (R2);
then acid neutralization of the residue (R2) may be carried out to obtain, after filtration, on the one hand, an aqueous phase (A3) and, on the other hand, a residue (R3);
then it is possible to rinse the residue (R3) with distilled water to obtain, after filtration, on the one hand, an aqueous phase (A4) and, on the other hand, a residue (R4);
then a hot extraction and a filtration of the residue (R4) may be carried out to obtain, on the one hand, a residue (R5) and, on the other hand, an agar gel;
and then extraction with hot water of the residue (R5) may be carried out to obtain an aqueous phase (A5);
then a freeze-thawing and/or mechanical pressing of the agar gel may be carried out to obtain, on the one hand, a syneresis juice (JS) and a pure agar gel;
the aqueous phases (A1) to (A5) and the syneresis juice (JS) each also representing a desired extract,
the extract may be subjected to a treatment with ethanol to obtain, on the one hand, an ethanolic extract (EE) and, on the other hand, a precipitate, said ethanolic extract being subjected to fractionation by ultrafiltration or by size exclusion allowing isolation of an extract fraction containing at least one oligosaccharide having from 2 to 50 ose units covalently bound to one another, and polysaccharides having more than 50 ose units covalently bound to one another, which can be contained without exceeding 0.01% by weight relative to total oligosaccharides/polysaccharides.

12. The method according to claim 1, wherein the extract or extract fraction has been concentrated, dehydrated or lyophilized.

13. The method according to claim 1, wherein the extract or the extract fraction is in the liquid state in an aqueous medium.

14. The method according to claim 1, wherein the extract or the extract fraction is in the form of powder or granules.

15. The method according to claim 1, wherein are treated agronomically useful plants, field crops, including oilseeds, protein crops, cereals, fruit trees, horticultural plants, grassland plants, and market garden plants.

16. The method according to claim 1, wherein the liquid extract or liquid extract fraction is applied to the plant or part of the plant or grains or seeds or on the soil or substrate at a concentration of oligosaccharide(s) of 0.0001 to 100 g/L.

17. The method according to claim 16, wherein the liquid extract or liquid extract fraction is applied to the plant or part of the plant or grains or seeds or on the soil or substrate at a concentration of oligosaccharide(s) of 1 to 10 mg/L.

18. The method according to claim 1, wherein the extract or the extract fraction is applied at a rate of 1 to 1000 g of oligosaccharides per hectare.

19. The method according to claim 1, wherein the application is carried out 1 to 20 times per year of culture.

20. The method according to claim 1, wherein the extract or extract fraction incorporates in a phytosanitary or fertilizer product or with at least one adjuvant chosen from surfactants, dispersants, preserving agents, anti-caking agents, trace elements, amendments, deficiency-correcting agents, fungicides, insecticides, herbicides, growth hormones.
